(19) United States
(12) Patent Application Publication
(10) Pub. No.: US 2007/0040812 A1
(43) Pub. Date: Feb. 22, 2007

(54) Internet phone integrated with touchpad functions

(76) Inventors: Kuan-Chun Tang, Toufen Township (TW); Wen-Jun Chen, Magung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/362,016

(22) Filed: Feb. 27, 2006

(30) Foreign Application Priority Data
Aug. 19, 2005 (TW) 094214226

(51) Int. Cl. G09G 5/00

(52) U.S. Cl. 345/173

(57) ABSTRACT

An Internet phone comprises a touchpad on which a panel is provided and several regions are defined on the panel for inputting by object touch, a mode-switching region on the panel for being touched to switch the touchpad among various modes, several icons in the defined regions for supporting the operations in the various modes, a display device for displaying the information inputted on the panel, and a communication interface serving as a communication channel between the Internet phone and other electronic devices. The various modes includes a telephone mode, a handwriting input mode and a cursor mode.

### FIELD OF THE INVENTION

The present invention is related generally to an Internet phone and, more particularly, to an Internet phone integrated with touchpad functions.

### BACKGROUND OF THE INVENTION

As shown in FIG. 1, a traditional Internet phone 100 utilizes a physical keypad 110 as an input device, transmits data to a computer via a communication interface 120 such as USB, and implements interface integration with an instant messaging software such as Skype, in order to realize dialing function and the inter-operation with the instant messaging software. With the development of the network technology, however, the function of an Internet phone relying merely on the physical keypad 110 for inputting can no longer fulfill the requirement of users, thus there is a need for an input device with multiple input modes to expand the functions of the Internet phone.

A touchpad may serve as an input device which allows objects, e.g., conductive objects such as fingers or styluses, to slide or touch on a smooth panel thereof, so that a cursor on a window can implement relative movement, absolute coordinate movement or other extension functions such as virtual keys functions, in order to realize various modes including handwriting input, cursor or telephone. Due to the small thickness of a touchpad, it can be designed into ultra-thin notebook computers, keyboards, digital media players or other devices. Furthermore, since it is not a mechanical design, its maintenance is very simple. FIG. 2 shows a two-dimensional touchpad 200, which comprises a panel 210, a Y-axis sensing layer 220, an insulation layer 230, an X-axis sensing layer 240 and a substrate 250. When a finger 260 touches on the panel 210, the sensed value such as capacitance or resistance at the touched position will change, and a control circuit connected to the touchpad 220 can transform the capacitance or resistance on the touchpad 200 into the sensed value, as depicted in FIG. 3, to determine the touched position, the shift and the moving direction of the finger, so that the touchpad 200 has various input modes for handwriting, cursor and telephone, which can significantly expand the functions and applications of an Internet phone when it is integrated with the Internet phone.

Therefore, it is desired an Internet phone integrated with touchpad functions.

### SUMMARY OF THE INVENTION

One object of the present invention is to provide an Internet phone integrated with touchpad functions, in order to expand the functions of the Internet phone.

Another object of the present invention is to provide an Internet phone integrated with touchpad functions, in order to save the cost of keypad mechanism.

Yet another object of the present invention is to provide an Internet phone integrated with touchpad functions, in order to achieve the waterproof and the molding as a whole manufactured feature.

According to the present invention, an Internet phone integrated with touchpad functions comprises a touchpad on which a panel is provided, and several regions are defined on the panel for inputting by object touch, a mode-switching region on the panel for switching among various modes, several icons in the defined regions for supporting the operations in the various modes, a display device for displaying the information input through the panel, and a communication interface as a communication channel between the Internet phone and electronic devices, wherein the various modes includes a telephone mode, a handwriting input mode and a cursor mode.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a traditional Internet phone;

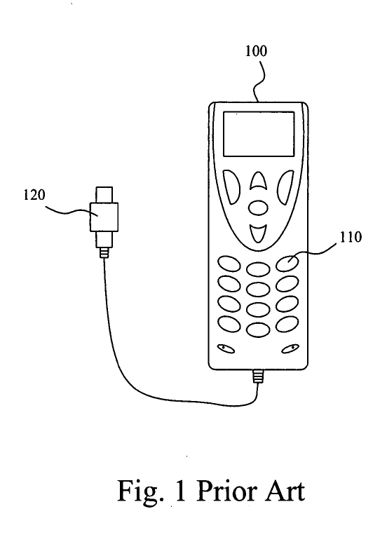

FIG. 2 shows a two-dimensional touchpad;

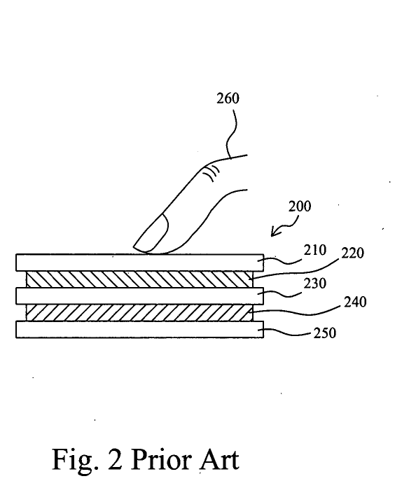

FIG. 3 shows a relationship between the sensed value and touched position on the touchpad shown in FIG. 1;

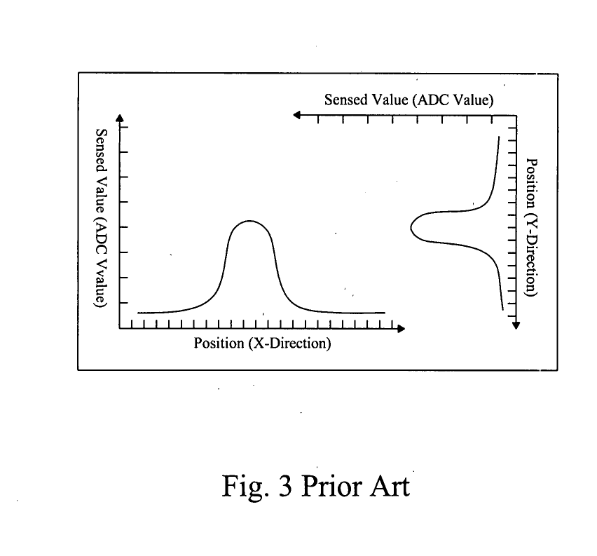

FIG. 4 shows an Internet phone integrated with touchpad functions according to the present invention;

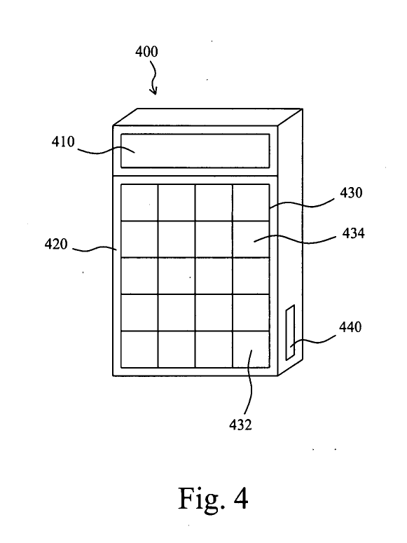

FIG. 5 shows a relationship between actions and the regions of a panel under different modes;

FIG. 6 shows an operation of an Internet phone in a telephone mode;

FIG. 7 shows an operation of an Internet phone in a handwriting input mode; and

FIG. 8 shows an operation of an Internet phone in a cursor mode.

### DETAILED DESCRIPTION OF THE INVENTION

According to the present invention, an Internet phone integrated 400 comprises a touchpad 420, on which a panel 430 is provided and several regions 434 are defined on the panel 430, a mode-switching region 432 on the panel 430 for switching among various modes including a telephone mode, a handwriting input mode and a cursor mode, a display device 410 such as an LCD display for displaying the information input through the panel 430, and a communication interface 440 as a communication channel between the Internet phone 400 and external electronic devices such as a computer. The regions 434 are printed with various icons thereon for supporting the operations in various modes. The communication interface 440 includes wired communication interface such as USB, or wireless communication interface such as radio frequency (RF) or the Bluetooth communication protocol. Preferably, the Internet phone 400 has both wired and wireless communication interfaces.

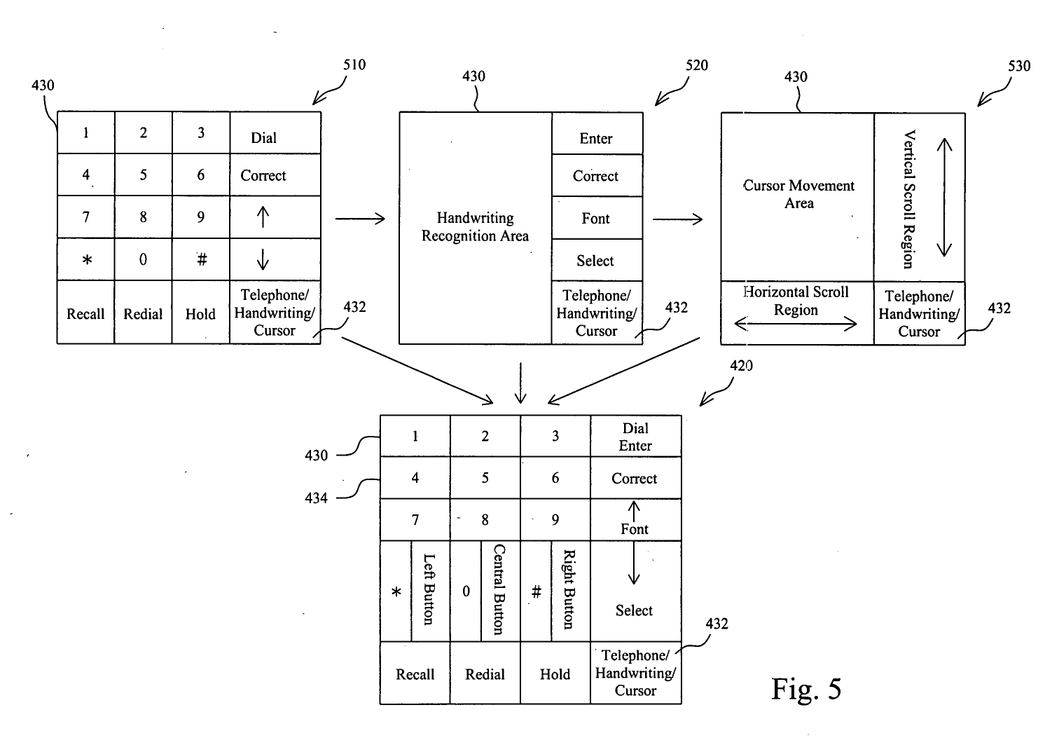

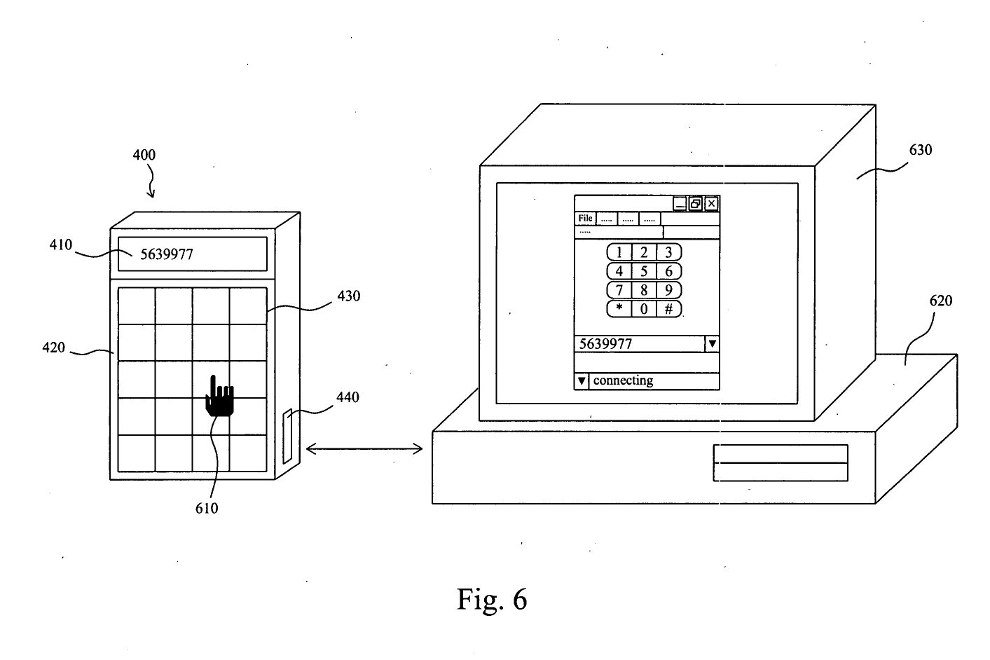

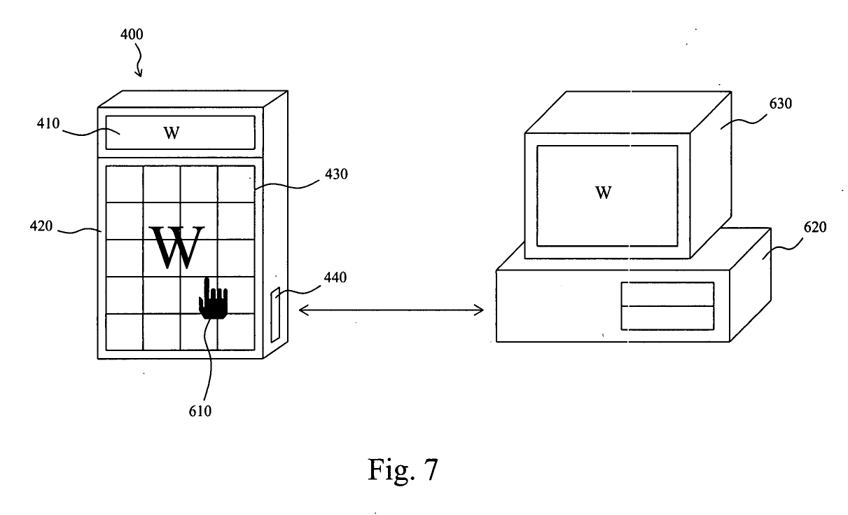

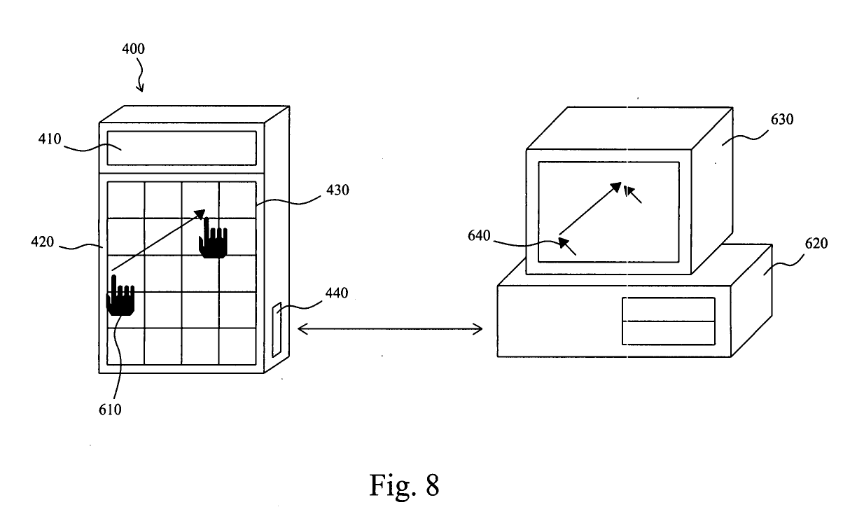

FIG. 5 shows a relationship between actions and the regions 434 of the panel 430 under different modes, FIG. 6 shows an operation of the Internet phone 400 in a telephone mode, FIG. 7 shows an operation of the Internet phone 400 in a handwriting input mode, and FIG. 8 shows an operation of the Internet phone 400 in a cursor mode. Referring to FIG. 5 and FIG. 6, when a user touches on the mode-switching region 432 to switch the touchpad 420 to a telephone mode, as indicated by numeral 510, the printed patterns including digits from ‘0’ to ‘9’, signs ‘*’ and ‘#’, and keys ‘dial’, ‘correct’, ‘up’, ‘down’, ‘recall’, ‘redial’ and ‘hold’ on the panel 430 provide the function of telephone dialing. The user may touch the panel 430 with an object 610 such as finger on the regions corresponding to the telephone number to be dialed, as shown in FIG. 6, then the dialed telephone number is displayed on the display device 410 and transmitted by the communication interface 440 to a computer 620 where after processed by an instant messaging software the dialed telephone number and the calling status are shown on a monitor 630. In the Internet phone 400, the touchpad 420 takes the role of a physical keypad, thus saving the cost of a keypad component and mechanism and achieving cost reduction. Furthermore, since the case of the Internet phone 400 has no extra opening for a physical keypad, it can be molded as a whole manufactured feature with the benefits of elegance, waterproof and dustproof.

Referring to FIG. 5 and FIG. 7, when the user touches on the mode-switching region 432 to switch the touchpad 420 to a handwriting input mode, as indicated by numeral 520, the handwriting recognition area and printed indications of ‘enter’, ‘correct’, ‘font’ and ‘select’ on the panel 430 provide the function of handwriting input/recognition. The user may write on the handwriting recognition area on the panel 430 by an object 610 such as finger, as shown in FIG. 7, and the touchpad 420 is employed to provide the information about the position where the object presses on and the number of the touching fingers, and after processed by a handwriting recognition processor the recognized handwriting such as letters, characters and symbols are displayed on the display device 410, and transmitted through the communication interface 620 to the computer 620 and displayed on the monitor 630, so that the inputting speed of letters, characters and symbols is quickened and more convenient, enhancing the input function of the Internet phone 400. In another embodiment, the handwriting recognition processor is inside the computer 620, the information provided by the touchpad 420, such as the position where the object presses on and the number of the touching fingers, is transmitted to the computer 620 through the communication interface 440, and after processed by the handwriting recognition processor the recognized handwriting such as letters, characters and symbols are displayed simultaneously on the display device 410 and on the monitor 630.

Referring to FIG. 5 and FIG. 8, when the user touches on the mode-switching region 432 to switch the touchpad 420 to a cursor mode, as indicated by numeral 530, the cursor movement area, vertical scroll region, horizontal scroll region, and printed indications of left button, central button and right button on the panel 430 provide the function of an emulated mouse, such as cursor moving, left/central/right clicking and scrolling. The user may control the movement of a cursor in the cursor movement area on the panel 430, as shown in FIG. 8, the information of the object 610 such as finger sliding on the panel 430 is transmitted to the computer 620 through the communication interface 440 to control the movement of a cursor 640 on the monitor 630. The vertical scroll region and the horizontal scroll region are used to emulate a mouse to vertically scroll or horizontally scroll a window as to scroll the vertical and horizontal scroll bars in the Microsoft Office, and the regions corresponding to the left, right and central buttons are used to emulate the left, right and central buttons of a mouse. A finger-stroke recognition module can be additionally added to recognize the number of the fingers touching on the panel 430, so as to trigger various instructions, for instance, when the finger-stroke recognition module determines that there are two fingers touching on the panel 430, the function of clicking the left button of a mouse is performed, and when the finger-stroke recognition module determines that there are three fingers touching on the panel 430, the function of clicking the right button of a mouse is performed, so that the Internet phone 400 has the function of a mouse, significantly expanding the functions and applications of the Internet phone 400.

The Internet phone according to the present invention integrates the function of a touchpad, thus significantly enhancing the functions and applications of the Internet phone and fulfilling the requirement of users for the functions of the Internet phone. By use of a touchpad as an input device, the cost of physical keypad is saved, achieving the cost reduction. There is no extra opening on the case of the Internet phone, it can be molded as a whole manufactured feature with the benefits of elegance, waterproof and dustproof.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An Internet phone integrated with touchpad functions, comprising:
a touchpad having a panel and a plurality of regions on the panel defined for inputting by object touch;
a mode-switching region on said panel for being touched to switch said touchpad among a plurality of modes;
a plurality of icons in said plurality of regions for supporting operations in said plurality of modes;
a display device for displaying data that is inputted by on said panel; and
a communication interface for serving as a communication channel between said Internet phone and an electronic device.

2. The Internet phone of claim 1, wherein said plurality of modes comprise a telephone mode, a handwriting input mode and a cursor mode.

3. The Internet phone of claim 1, wherein said communication interface comprises a wired or wireless communication interface.

4. The Internet phone of claim 1, wherein said electronic device comprise a computer.

5. The Internet phone of claim 1, wherein said display device comprises an LCD display.
